(19) United States
(12) Patent Application Publication
(10) Pub. No.: US 2013/0270834 A1
(43) Pub. Date: Oct. 17, 2013

(54) WIND TURBINE GENERATOR WITH A STATOR SUPPORT STRUCTURE

(71) Applicants: Michael Staghøj, Ry (DK); Gerner Larsen, Hinnerup (DK); Niels Christian Olsen, Tjele (DK); Frank Møller Hansen, Arden (DK)

(72) Inventors: Michael Staghøj, Ry (DK); Gerner Larsen, Hinnerup (DK); Niels Christian Olsen, Tjele (DK); Frank Møller Hansen, Arden (DK)

(73) Assignee: VESTAS WIND SYSTEMS A/S, Aarhus (DK)

(21) Appl. No.: 13/978,326

(22) PCT Filed: Jan. 5, 2011
(86) PCT No.: PCT/EP2011/050083

§ 371 Date: Jul. 3, 2013

(51) Int. Cl. H02K 1/18; F03D 9/00

(52) U.S. Cl. CPC H02K 1/182; F03D 9/002
USPC 290/55; 310/90

(57) ABSTRACT

A generator (5) for a wind turbine (1) and a wind turbine (1) are disclosed. The generator (5) comprises a rotor (3) configured to rotate about a rotational axis, and at least one stator (4) arranged next to the rotor (3), each stator (4) comprising at least one flux-generating module (9) facing the rotor (3) but spaced therefrom. The flux-generating module(s) (9) is/are mounted on a stator support structure (7, 10). The stator support structure (7, 10) defines a pre-loaded spring force acting against magnetic forces occurring between the rotor (3) and the flux-generating module(s) (9) during operation of the generator (5). The preloaded spring force is adjustable, e.g. by means of a piston arrangement (17). Thereby it is possible to maintain a preloaded spring force which is capable of acting against the magnetic forces occurring between the rotor (3) and the flux-generating module(s) (9), even if operating conditions are changed. Furthermore, the preloaded spring force may be adjusted to compensate for inaccuracies originating from production tolerances of the stator support structure (7, 10). A uniform and constant air gap can thereby be maintained between the rotor (3) and the flux-generating module(s) (9).

### FIELD OF THE INVENTION

The present invention relates to a generator for a wind turbine. The generator of the invention allows an air gap between a rotor and a stator of the generator to be controlled accurately, even for large diameter rotors and stators. The present invention further relates to a wind turbine comprising such a generator, and to a method for controlling an air gap between a rotor and a flux-generating module of a stator of a generator for a wind turbine.

### BACKGROUND OF THE INVENTION

Generators normally comprise a rotor and a stator, the rotor being arranged rotatably relative to the stator with a small air gap there between. It is necessary to achieve and maintain a high precision in the air gap between the rotor and the stator since the air gap, also for very large generators, has to be quite small, and generally only a few millimetres. To this end the rotor and the stator have previously been designed very rigid and heavy.

US 2010/0045047 A1 discloses a wind turbine including a direct drive generator with a stator arrangement, a rotor arrangement substantially arranged around the stator arrangement and a longitudinal centre axis. The stator arrangement includes a stator support structure, which includes at least one substantially radial extending stator support element. The stator support element is substantially rigid in the radial direction and is at least partially flexible in the direction of the centre axis of the generator.

### SUMMARY OF THE INVENTION

It is an object of embodiments of the invention to provide a generator for a wind turbine in which the size of an air gap between rotor and stators can be easily controlled.

It is a further object of embodiments of the invention to provide a wind turbine comprising a generator in which the size of an air gap between rotor and stators can be easily controlled.

It is an even further object of embodiments of the invention to provide a method for controlling an air gap between rotor and stators of a generator in an accurate manner.

According to a first aspect the invention provides a generator for a wind turbine, the generator comprising:
a rotor configured to rotate about a rotational axis, and
at least one stator arranged next to the rotor, each stator comprising at least one flux-generating module facing the rotor but spaced therefrom,
   wherein the flux-generating module(s) is/are mounted on a stator support structure, said stator support structure defining a preloaded spring force acting against magnetic forces occurring between the rotor and the flux-generating module(s) during operation of the generator, and wherein the preloaded spring force is adjustable.

The rotor is configured to rotate about a rotational axis, and the stator(s) is/are arranged next to the rotor. Accordingly, when the rotor rotates about the rotational axis, it performs rotational movements relative to the stator(s), and thereby relative to the flux-generating modules. This relative movement causes electrical energy to be produced by the generator.

The flux-generating modules are arranged in such a manner that they face the rotor, but are spaced therefrom. This forms an air gap between the rotor and the flux-generating modules. The rotor and the flux-generating modules of the stator include permanent magnets, electromagnetic windings, combinations thereof, or other active materials configured to provide a magnetic flux across the air gap sufficient to generate electricity.

The flux-generating modules are mounted on a stator support structure. The stator support structure defines a preloaded spring force acting against magnetic forces occurring between the rotor and the flux-generating modules during operation of the generator. The preloaded spring force ensures that any fluctuations in the size of the air gap, e.g. due to variations in the rotor, are counteracted, thereby ensuring that a substantially uniform air gap is maintained between the rotor and the flux-generating modules.

The preloaded spring force is adjustable. Thereby it can be ensured that the preloaded spring force is always of a size and direction which matches the magnetic forces occurring between the rotor and the flux-generating modules. Accordingly, even if the operating conditions change over time, or if the stator support structure undergoes changes during operation, the preloaded spring force can be adjusted to match the new situation, and accurate control of the size of the air gap between the rotor and the flux-generating modules can be maintained. Furthermore, the preloaded spring force can be adjusted in order to compensate for inaccuracies originating from production tolerances of the stator support structure. This allows the requirements of the production tolerances to be decreased.

At least one of the stator(s) may comprise a first flux-generating module and a second flux-generating module arranged on opposing sides of the rotor. According to this embodiment, at least one set of flux-generating modules is arranged opposite to each other with the rotor rotating in a channel formed between the flux-generating modules. An air gap is formed between the rotor and the first flux-generating module, as well as between the rotor and the second flux-generating module.

The first flux-generating module and the second flux-generating module may be mounted on a common stator support structure. According to this embodiment, the sizes of the air gaps formed between rotor and the first and second flux-generating modules, respectively, are controlled by means of the adjustable preloaded spring force of the common stator support structure. As an alternative, the first flux-generating module and the second flux-generating module may be mounted on separate stator support structures, in which case the air gaps formed between the rotor and the first and second flux-generating modules, respectively, are controlled by means of the adjustable preloaded spring force of the corresponding stator support structures.

The stator support structure may comprise an adjustment mechanism for adjusting the preloaded spring force. According to this embodiment, the preloaded spring force is adjusted by operating the adjustment mechanism.

The adjustment mechanism may comprise a piston arrangement arranged in or on the stator support structure, said piston arrangement being adapted to manipulate a stiffness of the stator support structure. According to this embodiment, the preloaded spring force is adjusted by operating the piston arrangement. When the piston arrangement is operated, the stiffness of the stator support structure is manipulated. Thereby the ability of the stator support structure to flex or bend in response to forces acting in the air gap, such as forces occurring between the rotor and the flux-generating modules, is changed. Thus, according to this embodiment, the preloaded spring force is at least partly provided by the stiffness of the stator support structure. The preloaded spring force may, alternatively or additionally, be at least partly provided by other material properties of the stator support structure.

The piston arrangement may be arranged in an interior part of the stator support structure. Alternatively, it may be arranged along an external surface of the stator support structure and/or between various parts of the stator support structure.

Alternatively or additionally, the adjustment of the preloaded spring force may be at least partly obtained by means of manipulation of a geometry of the stator support structure, e.g. the size or shape of the stator support structure or a part of the stator support structure, and/or a relative position between two parts of the stator support structure. Such manipulations may, e.g., be performed by means of a piston arrangement.

The stator support structure may have a shape which provides an even distribution of stress in the stator support structure. According to this embodiment, the shape of the stator support structure ensures that stress occurring in the stator support structure during operation of the generator, is distributed in a substantially even manner throughout the stator support structure. Thereby it is prevented that certain parts of the stator support structure must absorb large stress forces which could result in fatigue in such parts of the stator support structure. Accordingly, the expected lifetime of the generator is maximised.

The preloaded spring force may be at least partly provided by a shape of the stator support structure. According to this embodiment, the stator support structure is designed with a shape which naturally allows the stator support structure to flex, thereby acting against magnetic forces occurring between the rotor and the flux-generating modules.

According to one embodiment, the stator support structure may define a substantially cylindrical shape. Cylindrical objects are very stable, and forces acting on a cylindrical object are distributed substantially evenly across the object. Furthermore, for objects where the cylinder wall is broken along a line which is substantially parallel to the longitudinal axis of the cylinder, and a part of the cylinder wall is removed along this line, the cylinder is flexible in a manner which allows a gap defined between the parts of the cylinder wall arranged adjacent to the line to be increased or decreased. Thereby the cylindrical shape is very suitable for allowing adjustment of an air gap defined between a rotor and a flux-generating module.

At least one of the flux-generating module(s) may be mounted on the stator support structure via a centre portion of the flux-generating module. Thereby it is obtained that forces transferred between the stator support part and the flux-generating module will not tend to ‘tilt’ the flux-generating module, thereby creating a variation in the size of the air gap defined between the rotor and the flux-generating module along the radial direction. Instead it is ensured that the entire flux-generating module is moved substantially along a direction towards or away from the rotor, thereby ensuring a uniform air gap between the rotor and the flux-generating modules.

At least one of the flux-generating module(s) may further be provided with one or more bearing elements. The bearing elements support the rotor during rotational movements of the rotor relative to the stator(s).

The bearing element(s) may be or comprise fluid bearings, such as air bearings. In this case, a fluid film is formed at an interface between the rotor and each bearing element, and this fluid film provides a bearing effect allowing the rotor to rotate relative to the stator(s) with substantially no friction between the rotor and the stator(s) since the fluid film prevents direct contact between the rotor and the stator(s). Furthermore, the fluid film allows for compensation of fluctuations or variations occurring in the air gap between the rotor and the flux-generating modules. Thus, the fluid film helps maintaining the required air gap between the rotor and each flux-generating module.

As an alternative, other kinds of bearings may be used, such as roller bearings, slide bearings, hydrodynamic bearings, hydrostatic bearings, etc.

Each stator may comprise at least two subunits, each subunit comprising at least one first flux-generating module and at least one second flux-generating module arranged pairwise on opposing sides of the rotor.

The subunits may be arranged side-by-side along a moving direction of the rotor, i.e. along the direction in which the rotor passes the stator(s) when it rotates about the rotational axis. During rotation of the rotor, a given part of the rotor will, in this case, first pass a first subunit, and the flux-generating module(s) thereof, and subsequently a second subunit, and the flux-generating module(s) thereof.

The subunits may be movable relative to each other along a direction which is substantially transverse to the moving direction of the rotor. In this case, the subunits are individually movable in a direction towards and away from the rotor. Accordingly, when the rotor passes through a given stator, the distance between the rotor and a given subunit of the stator may change without affecting the distance between the rotor and a neighbouring subunit. This makes it possible to compensate for small irregularities in the rotor, thereby helping in maintaining a substantially constant air gap between the rotor and the flux-generating modules.

The generator may comprise at least two stators arranged along separate angular segments of the rotor. According to this embodiment, the stators are arranged in such a manner that only part of the rotor is arranged adjacent to a stator at any given time, i.e. the stators do not occupy the entire periphery defined by the rotor.

The separate angular segments are preferably distributed substantially uniformly along the periphery defined by the rotor, and the stators preferably occupy angular segments of substantially equal size. For instance, the generator may comprise two stators arranged substantially opposite to each other, e.g. each occupying an angular segment of approximately 60°. As an alternative, the generator may comprise three stators arranged with approximately 120° between neighbouring stator segments, or the generator may comprise any other suitable or desirable number of stators.

As an alternative, the generator may comprise a single stator arranged along the entire periphery of the rotor, i.e. the stator extending along 360°. As another alternative, a single stator may extend along a smaller angular part of the periphery defined by the rotor.

The generator may be an axial flux generator with an air gap between the flux-generating modules and the rotor extending substantially parallel to the rotational axis of the rotor. Thereby the flux lines generated as the rotor moves past the flux-generating modules also extend substantially parallel to the rotational axis of the rotor. Accordingly, the forces acting between the rotor and the stators also extend substantially parallel to the rotational axis of the rotor, thereby minimising forces acting substantially perpendicularly to the rotational axis. This reduces the loads introduced in the generator.

Alternatively, the generator may be a radial flux generator with an air gap between the flux-generating modules and the rotor extending substantially perpendicular to the rotational axis of the rotor.

According to a second aspect the invention provides a wind turbine comprising at least one generator according to the first aspect of the invention.

The wind turbine may comprise two generators according to the first aspect of the invention, the rotors of said generators being mounted on a common rotational shaft. According to this embodiment, the generators may, e.g., be mounted on opposite sides of a tower construction carrying the generators. Thereby the power production of the wind turbine can be significantly increased, possibly doubled, as compared to a wind turbine comprising only one generator.

The rotor(s) of the generator(s) may be connected to a set of wind turbine blades, i.e. the rotational movements of the rotor(s) may be a result of the wind acting on the wind turbine blades.

The wind turbine may be a horizontal axis wind turbine, i.e. it may be of a kind having a set of wind turbine blades mounted on or connected to a main axle arranged rotationally, and extending along a substantially horizontal direction.

As an alternative, the wind turbine may be a vertical axis wind turbine, i.e. it may be of a kind having a set of wind turbine blades mounted on or connected to a main axle arranged rotationally, and extending along a substantially vertical direction.

The generator may be a direct drive generator, or a gearless generator. According to this embodiment, the rotor is driven directly by the wind turbine blades, i.e. the wind acting on the wind turbine blades directly provides the relative movements between the rotor and the stators without the use of a gear stage. As an alternative, the wind turbine may comprise a gear system arranged between the wind turbine blades and the rotor of the generator. The gear system normally increases the rotational speed, i.e. the rotational speed of an input shaft of the generator is higher than the rotational speed of a main axle coupled to and driven by the wind turbine blades.

According to a third aspect the invention provides a method for controlling an air gap between a rotor and a flux-generating module of a stator of a generator for a wind turbine, the method comprising the steps of:
monitoring a size of an air gap between the rotor and the flux-generating module,
comparing the monitored size of the air gap to a predefined threshold value,
in the case that the monitored size of the air gap drops below the predefined threshold value, adjusting a preloaded spring force of a stator support structure having the flux-generating module mounted thereon, thereby restoring an original air gap between the rotor and the flux-generating module.

It should be noted that a person skilled in the art would readily recognise that any feature described in combination with the first aspect could also be combined with the second aspect or the third aspect, that any feature described in combination with the second aspect of the invention could also be combined with the first aspect or the third aspect, and that any feature described in combination with the third aspect of the invention could also be combined with the first aspect or the second aspect.

The third aspect of the invention relates to a method for controlling an air gap between a rotor and a flux-generating module of a stator of a generator of a wind turbine. The generator may advantageously be a generator according to the first aspect of the invention, and the remarks set forth above with reference to the first aspect of the invention are therefore equally applicable here.

According to the method of the third aspect of the invention, the size of the air gap is monitored. If it is detected that the size of the air gap drops below a predefined threshold value, then a preloaded spring force of a stator support structure having the flux-generating module mounted thereon is adjusted. Thereby an original air gap between the rotor and the flux-generating module is restored.

Thus, as described above with reference to the first aspect of the invention, it is possible to adjust the preloaded spring force in such a manner that it is always capable of acting against magnetic forces occurring between the rotor and the flux-generating modules. Accordingly, a constant and uniform air gap is maintained.

The step of adjusting the preloaded spring force may comprise operating a piston arranged in or on the stator support structure. This has already been described in detail above with reference to the first aspect of the invention.

### BRIEF DESCRIPTION OF THE DRAWINGS

The invention will now be described in further detail with reference to the accompanying drawings in which

FIG. 1 is a perspective view of a wind turbine according to an embodiment of the invention,

FIG. 2 is a perspective view of a stator of a generator according to an embodiment of the invention,

FIG. 3 shows a detail of the stator of FIG. 2,

FIG. 4 shows another detail of the stator of FIG. 2,

FIG. 5 is a cross sectional view of a generator comprising the stator of FIG. 2,

FIG. 6 is a perspective view of a stator of a generator according to another embodiment of the invention, and

FIG. 7 is a cross sectional view of the stator of FIG. 6.

### DETAILED DESCRIPTION OF THE DRAWINGS

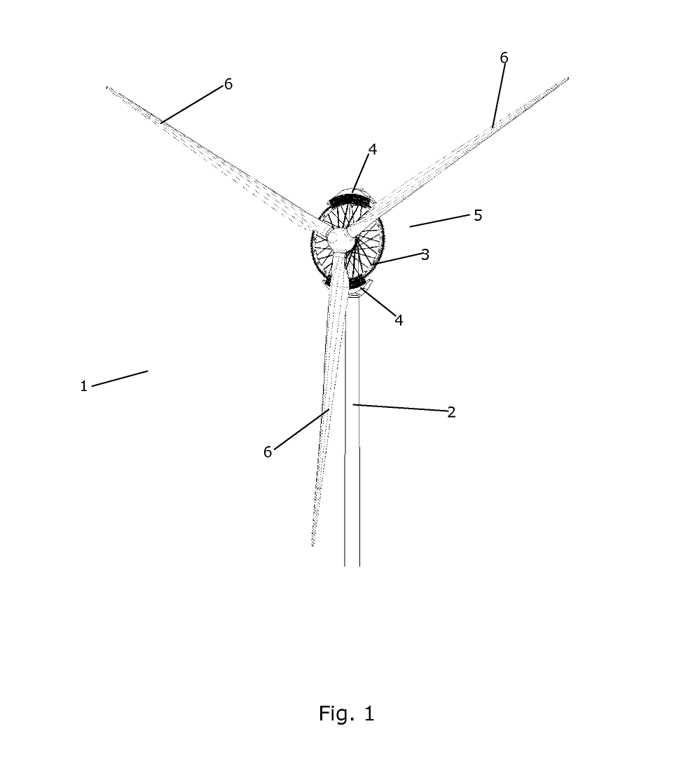

FIG. 1 is a perspective view of a wind turbine 1 according to an embodiment of the invention. The wind turbine 1 comprises a wind turbine tower 2 having a rotor 3 and two stators 4 mounted thereon, the rotor 3 and the stators 4 forming part of a generator 5. Three wind turbine blades 6 are mounted on the rotor 3 in such a manner that the rotor 3 rotates relative to the stators 4 due to the wind acting on the wind turbine blades 6.

The wind turbine 1 is a direct drive wind turbine, i.e. the rotor 3 of the generator 5 is driven directly by the wind turbine blades 6 without a gear stage to increase rotational speeds.

The stators 4 are arranged substantially opposite to each other, each occupying an angular segment of approximately 60° along a periphery defined by the rotor 3. Although only two stators 4 are shown, an additional number of stators may be included in alternative embodiments.

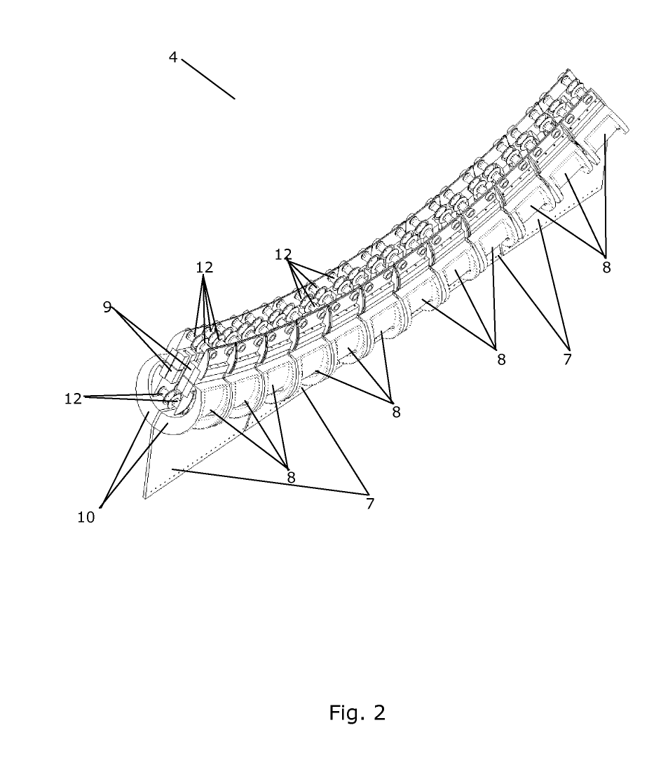

FIG. 2 is a perspective view of a stator 4 of a generator according to an embodiment of the invention. The stator 4 comprises four stator frames 7, each having three subunits 8 mounted thereon, the subunits 8 being arranged side-by-side. Each subunit 8 comprises two flux-generating modules 9 arranged opposite to and spaced from each other, thereby defining a passage there between, through which a rotor (not shown) can pass during normal operation of the generator. The rotor carries permanent magnets, electromagnets, or some other active material or component designed to interact with the flux-generating modules 9 to generate electric current. Specifically, an air gap is maintained between the rotor and each flux-generating module 9. As the active material of the rotor moves past the flux-generating modules 9, flux moves through the air gap. This moving flux induces a current in windings mounted near the flux-generating modules 9.

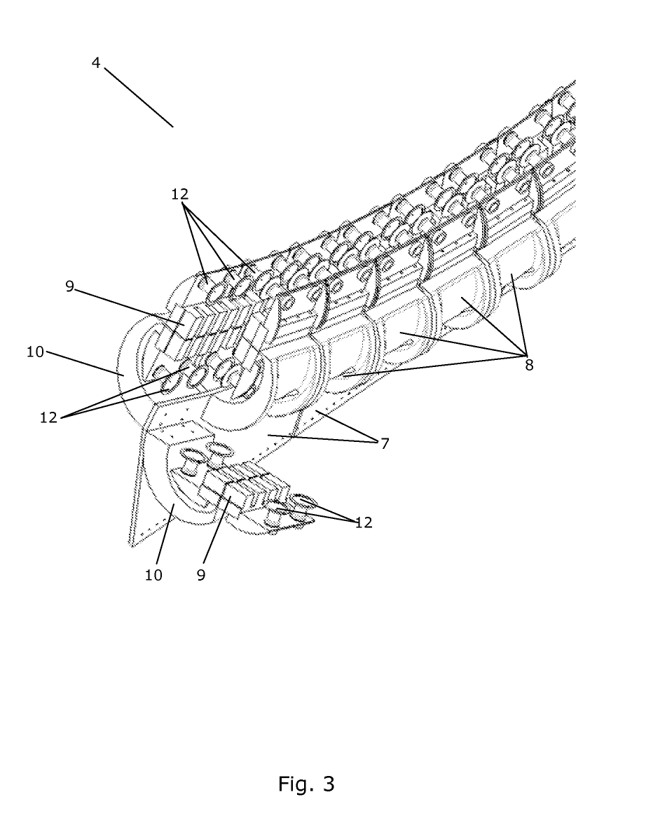

The flux-generating modules 9 are each mounted on a stator support part 10, and for each subunit 8, two stator support parts 10 are connected to each other via a hinge connection (not shown), thereby allowing the stator support parts 10 and flux-generating modules 9 mounted thereon to be moved relative to each other via the hinge connection. This will be described in further detail below with reference to FIG. 3.

The subunits 8 are mounted on the stator frame 7 in such a manner that they are movable relative to each other along a direction which is substantially transverse to the direction of movement of the rotor during normal operation of the generator, i.e. in a direction towards or away from the passage defined between the flux-generating modules 9. Thus, in the case that small irregularities are present in the rotor (e.g., due to deflections, machine tolerances, etc.), or other variations in the air gaps between the rotor and the flux-generating modules 9 occur, such irregularities or variations can be compensated by one subunit 8 moving slightly relative to a neighbouring subunit 8, without affecting the neighbouring subunit 8. Thereby it is possible to maintain a uniform and substantially constant air gap between the rotor 3 and each of the flux-generating modules 9. The transverse movements of the subunits 8 are provided passively due to inherent properties, such as material properties, geometric design, etc., of the stator frames 7 and/or the stator support parts 10. The stator frames 7 and the stator support parts 10 in combination form or form part of a stator support structure.

The stator frames 7 and/or the stator support parts 10 define a preloaded spring force acting against magnetic forces occurring between the rotor and the flux-generating modules 9 during operation of the generator. The preloaded spring force automatically ensures that any fluctuations in the air gap between the rotor and the flux-generating modules 9 is compensated, thereby helping in maintaining a uniform and constant air gap. The preloaded spring force is adjustable due to a mechanism which is not shown in FIG. 2.

Each subunit 8 is further provided with eight bearing units 12. Although the bearing units 12 are shown in the form of air bearings, it will be appreciated that other types of bearings (e.g., roller bearings, slide bearings, hydrodynamic bearings, hydrostatic bearings, etc.) may be used instead of or in addition to air bearings. Additionally, the number and location of the bearing units 12 may vary. In FIG. 2, the bearing units 12 of each subunit 8 are arranged above and below the flux-generating modules 9. Each bearing unit 12 includes a body defining a cavity with an open end facing the rotor. A source of pressurized fluid (not shown) is connected to each bearing unit 12, whose bodies direct the fluid against the rotor thereby creating a fluid film between the cavities and the rotor. The fluid film helps in maintaining a uniform air gap between the active material of the rotor and the flux-generating modules 9.

FIG. 3 shows the stator 4 of FIG. 2 in further detail. In FIG. 3 one of the stator support parts 10 of one of the subunits 8 has been moved relative to the other stator support part 10 of that subunit 8, via the hinge connection (not shown). Thus, one of the stator support parts 10, and thereby the flux-generating modules 9 mounted thereon, has been rotated away from the passage through which the rotor passes during normal operation of the generator. Thereby it is possible to gain access to a region between the rotor and the flux-generating modules 9. This allows service to be easily performed on parts in this region of the generator, e.g. on the flux-generating modules 9, the bearing units 12 and/or the rotor.

A method for performing service on a generator comprising the stator 4 of FIGS. 2 and 3 may be performed in the following manner. Initially, one of the stator support parts 10 (“first” stator support part) is fixated independent of the other stator support part 10 in the same sub-unit 8 (“second” stator support part), e.g. by attaching the stator support part 10 to a neighbouring subunit 8, thereby preventing the stator support part 10 from moving via the hinge connection. Then the bolt connection (not shown) between the two stator support parts 10 of the subunit 8 is released, thereby allowing relative movement between the stator support parts 10. Subsequently, the second stator support part 10, along with the flux-generating module 9 mounted thereon, is moved via the hinge connection to the position shown in FIG. 3. At this point it is possible to perform maintenance or service on the generator in the region between the rotor and the flux-generating modules 9, as described above. When the service has been completed, the second stator support part 10 is returned to the operating position shown in FIG. 2, via the hinge connection. The bolt connection between the stator support parts 10 is then re-established, and the fixation of the first stator support part 10 is released. Then the generator is once again ready for normal operation.

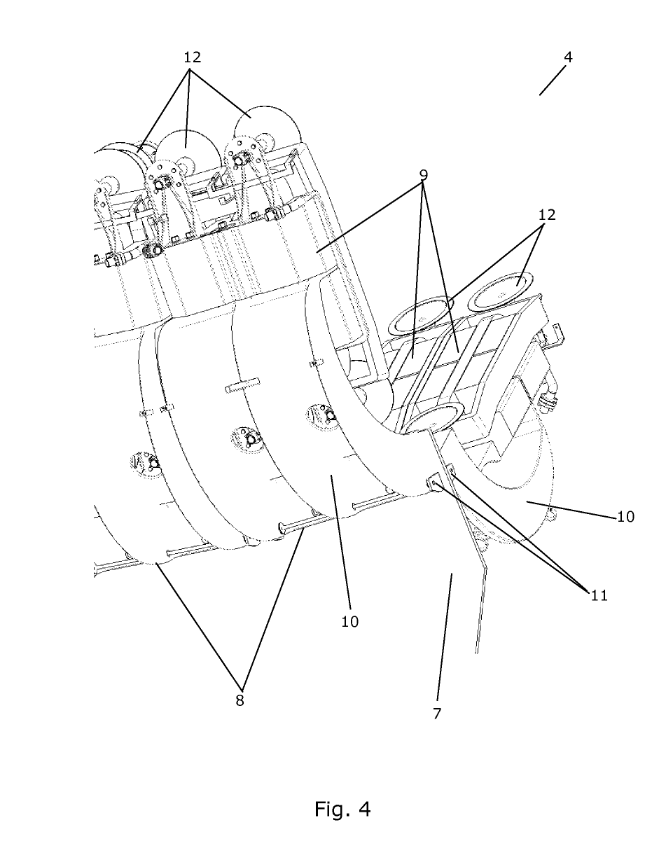

FIG. 4 shows another detail of the stator 4 of FIG. 2. In FIG. 4 the hinge connection 11 is visible.

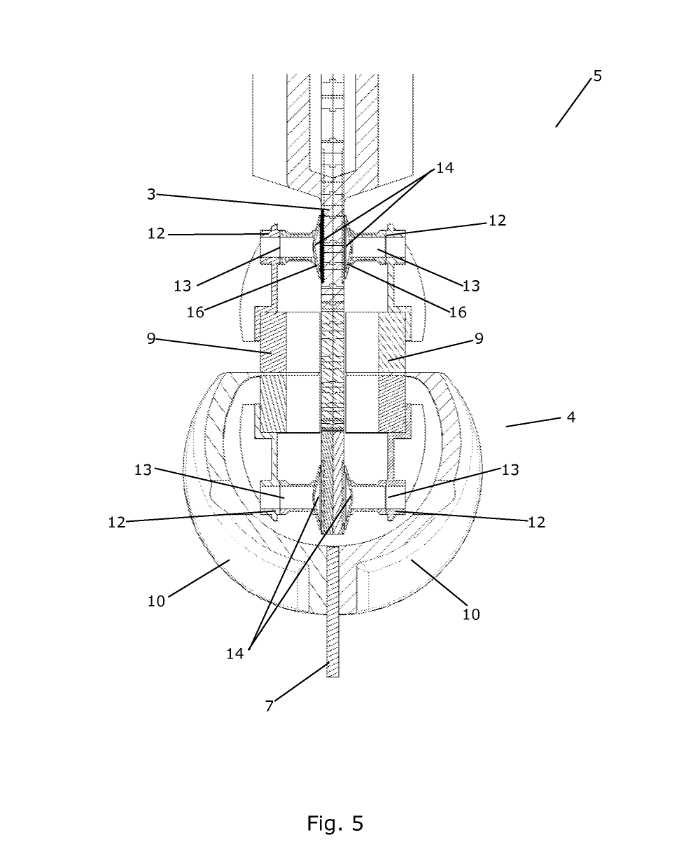

FIG. 5 is a cross sectional view of a generator 5 comprising the stator 4 of FIG. 2. In FIG. 4 the rotor 3 is arranged in the passage defined between the flux-generating modules 9 of the stator 4. It is also clear from FIG. 5 that the air gap defined between the rotor 3 and the flux-generating modules 9 is very small.

In FIG. 5 the shape of the stator support parts 10 can be clearly seen. Each stator support part 10 has a curved shape. The material thickness is thickest at the position where the stator support parts 10 are mounted on the stator frame 7, and decreases gradually along the curved shape in a direction away from the mounting point. Thereby the stator support parts 10 are more flexible at a position close to the flux-generating modules 9 than at a position close to the stator frame 7. Furthermore, the curved shape is designed in a manner which minimises strain introduced in the stator support part 10 during operation of the generator. The shape of the stator support part 10 is carefully selected in such a manner that a preloaded spring force is provided which acts against magnetic forces occurring between the rotor 3 and the flux-generating modules 9. More particularly, the magnetic forces occurring between the rotor 3 and the flux-generating modules 9 will tend to pull the flux-generating modules 9 towards the rotor 3. The shape of the stator support part 10 is designed in such a manner that this is automatically and passively counteracted by the stator support part 10.

The flux-generating modules 9 are mounted on the stator support parts 10 in such a manner that a contact point between a stator support part 10 and the corresponding flux-generating module 9 is positioned substantially halfway between an upper edge and a lower edge of the flux-generating module 9, i.e. approximately in a centre region of the flux-generating module 9. Furthermore, the shape of the stator support part 10 near this contact point is designed in such a manner that forces transferred between the stator support part 10 and the flux-generating module 9 are transferred along a direction which is substantially perpendicular to a radial direction defined by the rotor 3, as well as to the moving direction of the rotor 3. Thereby it is obtained that forces transferred between the stator support part 10 and the flux-generating module 9 will not tend to ‘tilt’ the flux-generating module 9, thereby creating a variation in the size of the air gap defined between the rotor 3 and the flux-generating module 9 along the radial direction. Instead it is ensured that the entire flux-generating module 9 is moved substantially along a direction towards or away from the rotor 3, thereby ensuring a uniform air gap between the rotor 3 and the flux-generating modules 9.

Four bearing units 12 are visible. Each bearing unit 12 includes a body 16 defining a cavity 14 with an open end facing the rotor 3. A source of pressurized fluid (not shown) is connected to each bearing unit 12, whose bodies 16 direct the fluid against the rotor 3 thereby creating a fluid film between the cavities 14 and the rotor 3. The fluid film helps in maintaining a uniform air gap between the active material of the rotor 3 and the flux-generating modules 9. In the bearing units 12 shown in FIGS. 2-5, the cavity 14 of each bearing unit 12 is fixedly connected to a fluid passage 13 guiding pressurized fluid from the source of pressurized fluid to the cavity 14.

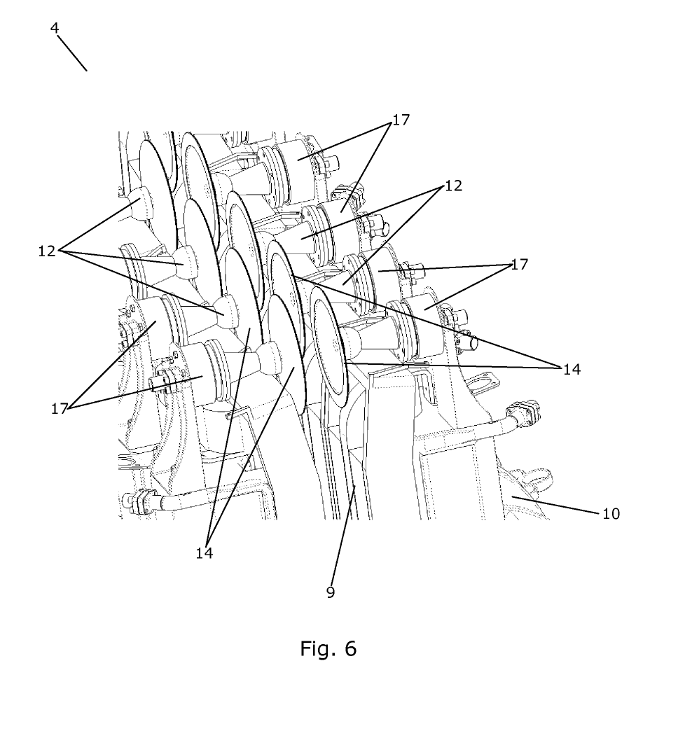

FIG. 6 is a perspective view of a stator 4 for a generator according to another embodiment of the invention. The stator is very similar to the stator 4 shown in FIGS. 2-5, and will therefore not be described in detail here. In the stator 4 of FIG. 6, each bearing unit 12 is mounted on a stator support part 10 via a piston arrangement 17. More particularly, each bearing unit 12 is connected to a flux-generating module 9 via the piston arrangement 17, and the flux-generating module 9 is in turn connected to a stator support part 10 as described above with reference to FIG. 5.

Each piston arrangement 17 is fluidly connected to a supply of gas or fluid (not shown) capable of driving the piston arrangement 17. Operating a given piston arrangement 17 causes the distance between the body 16 of the corresponding bearing unit 12 and the corresponding flux-generating module 9 to increase or decrease.

The bearing units 12 are arranged substantially in abutment with the rotor (not shown). Accordingly, the positions of the bearing units 12, and thereby the bodies 16 of the bearing units 12, are substantially fixed. Due to this, and since the connection between each flux-generating module 9 and the corresponding stator support part 10 is also substantially fixed, operation of a given piston arrangement 17 will change the preloaded spring force defined by the corresponding stator support part 10. Thus, if the piston arrangement 17 is operated in such a manner that the distance between the body 16 and the flux-generating module 9 is increased, then the preloaded spring force defined by the stator support part 10 is increased. Similarly, if the piston arrangement 17 is operated in such a manner that the distance between the body 16 and the flux-generating module 9 is decreased, then the preloaded spring force defined by the stator support part 10 is decreased.

Accordingly, the piston arrangements 17 allow the preloaded spring force defined by the stator support parts 10 to be adjusted. Thereby the requirements to production tolerances of the stator support parts can be lowered. This is a great advantage, since it is often desired that the size of the air gap between the flux-generating elements 9 and the rotor is only a few millimetres. However, production tolerances for the stator support part 10 are normally much larger than this, and it is therefore difficult to obtain an air gap which is sufficiently small, uniform and constant. According to the embodiment of the present invention which is shown in FIG. 6, the size of the air gap can be adjusted by operating the piston arrangements 17, thereby adjusting the preloaded spring force defined by the stator support parts 10, and thereby inaccuracies originating from production tolerances can be corrected. Furthermore, the piston arrangements 17 allow the preloaded spring force to be adjusted in the case that operating conditions are changed.

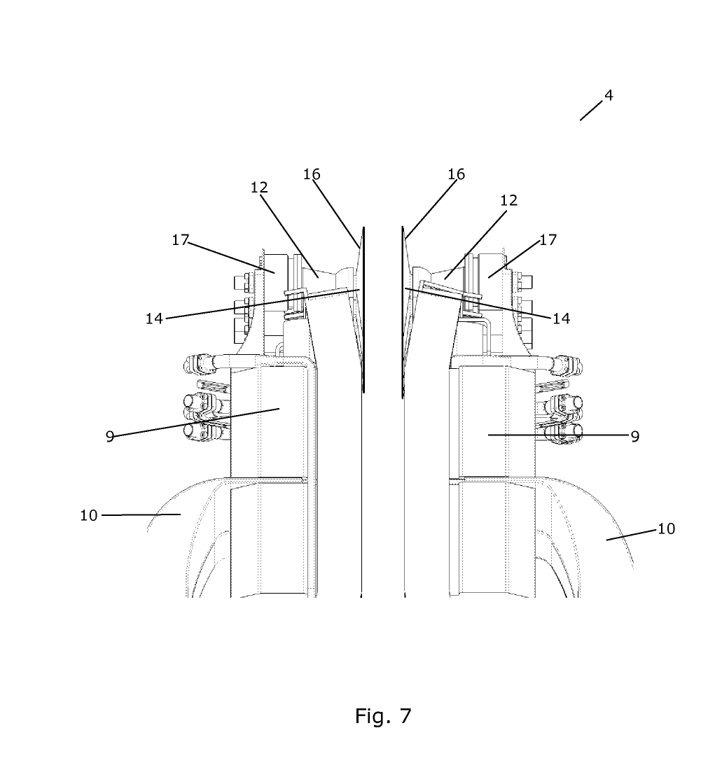

FIG. 7 is a cross sectional view of the stator 4 of FIG. 6, illustrating further details of the stator 4.

1. A generator for a wind turbine, the generator comprising:
a rotor configured to rotate about a rotational axis, and
at least one stator arranged next to the rotor, each stator comprising at least one flux-generating module facing the rotor but spaced therefrom,
wherein the flux-generating module(s) is/are mounted on a stator support structure, said stator support structure defining a preloaded spring force acting against magnetic forces occurring between the rotor and the flux-generating module(s) during operation of the generator, and wherein the preloaded spring force is adjustable.

2. The generator according to claim 1, wherein at least one of the stator(s) comprises a first flux-generating module and a second flux-generating module arranged on opposing sides of the rotor.

3. The generator according to claim 2, wherein the first flux-generating module and the second flux-generating module are mounted on a common stator support structure.

4. The generator according to claim 1, wherein the stator support structure comprises an adjustment mechanism for adjusting the preloaded spring force.

5. The generator according to claim 4, wherein the adjustment mechanism comprises a piston arrangement arranged in or on the stator support structure, said piston arrangement being adapted to manipulate a stiffness of the stator support structure.

6. The generator according to claim 1, wherein the adjustment of the preloaded spring force is at least partly obtained by means of manipulation of a geometry of the stator support structure.

7. The generator according to claim 1, wherein the stator support structure has a shape which provides an even distribution of stress in the stator support structure.

8. The generator according to claim 1, wherein the preloaded spring force is at least partly provided by a shape of the stator support structure.

9. The generator according to claim 1, wherein the stator support structure defines a substantially cylindrical shape.

10. The generator according to claim 1, wherein at least one of the flux-generating module(s) is mounted on the stator support structure via a centre portion of the flux-generating module.

11. The generator according to claim 1, wherein at least one of the flux-generating module(s) is further provided with one or more bearing elements.

12. The generator according to claim 11, wherein the bearing element comprises fluid bearings.

13. The generator according to claim 1, wherein each stator comprises at least two subunits, each subunit comprising at least one first flux-generating module and at least one second flux-generating module arranged pairwise on opposing sides of the rotor.

14. The generator according to claim 1, wherein the generator comprises at least two stators arranged along separate angular segments of the rotor.

15. The generator according to claim 1, wherein the generator is an axial flux generator, an air gap between the flux-generating modules and the rotor extending substantially parallel to the rotational axis of the rotor.

16. A wind turbine comprising at least one generator according to claim 1.

17. The wind turbine according to claim 16, the wind turbine comprising two generators, the rotors of said generators being mounted on a common rotational shaft.

18. The wind turbine according to claim 16, wherein the rotor of the generator is connected to a set of wind turbine blades.

19. The wind turbine according to claim 16, the wind turbine being a horizontal axis wind turbine.

20. The wind turbine according to claim 16, wherein the generator is a direct drive generator.

21. A method for controlling an air gap between a rotor and a flux-generating module of a stator of a generator for a wind turbine, the method comprising the steps of:
monitoring a size of an air gap between the rotor and the flux-generating module,
comparing the monitored size of the air gap to a predefined threshold value,
in the case that the monitored size of the air gap drops below the predefined threshold value, adjusting a preloaded spring force of a stator support structure having the flux-generating module mounted thereon, thereby restoring an original air gap between the rotor and the flux-generating module.

22. The method according to claim 21, wherein the step of adjusting the preloaded spring force comprises operating a piston arranged in or on the stator support structure.
